(19) United States
(12) Patent Application Publication
(10) Pub. No.: US 2018/0215000 A1
(43) Pub. Date: Aug. 2, 2018

(54) PRESPECIFIED HEIGHT SUCTION SUPPORT WITH PROTECTIVE ELASTOMERIC OVERFIT VACUUM SEAL MEMBERS AND SUPPORT MEMBERS

(71) Applicant: John Blick, Laguna Beach, CA (US)

(72) Inventor: John Blick, Laguna Beach, CA (US)

(21) Appl. No.: 15/422,197

(22) Filed: Feb. 1, 2017

(51) Int. Cl. B23Q 3/08; B25B 11/00

(52) U.S. Cl. CPC B23Q 3/088; B25B 11/005

(57) ABSTRACT

A high-modularization, prespecified height suction support with field replaceable protective elastomeric overfit vacuum seal members and support member assembly provides a stable body of closely toleranced prespecifiable height, upper and lower elastomeric overfit vacuum seal workpiece bearing members. The result is a protected overfit vacuum support that is damage resistant, protective, enables field repairability, and reduces the number of different spare parts needed. Overall cumulative height tolerance is from only five contributions and two pairs of the five contributions are from identical parts, three for a base plate and post structural assembly, and one each for two elastomeric overfit vacuum seal members supported by the support assembly.

### FIELD OF THE INVENTION

The present invention relates to improvements in the field of vacuum supports that use a vacuum to create force to hold the support in place, and especially with independent activation of a lower vacuum to stabilize the vacuum support against another surface, and with an upper vacuum to stabilize workpiece against the vacuum support, and more particularly to an individual prespecified height suction support with individually height toleranced members including protective elastomeric overfit vacuum seal members and members making up a support assembly.

### BACKGROUND OF THE INVENTION

As was described in U.S. Pat. No. 6,817,933, filed Oct. 25, 2002 and issued on Nov. 16, 2004 to the inventor of the instant application and entitled “FLEXIBLE DRESSABLE EDGE SUPPORT” and which is incorporated by reference herein, one technique has been to provide a support that is assembled and then treated to have upper material removed to form an exact height, level support surface. The top and/or bottom ends of the assembled supports included a raised seal member that constituted the overall sealing member. The main supporting rubber bearing material was machineable in place on a working table to insure that the factory assembled overall support would be brought to exactly the same height for product consistency and in order to prevent adjacently located supports from creating uneven support.

Exact height adjustment for multiple supports having polymeric interconnections was important for the '933 invention especially because the supports were closely located with respect to each other and intended to work as an integrated unit. Significant damage to one unit would generally cause a need for one or more units to be rebuilt and height re-dressed. In some cases all the units needed to be rebuilt and re-dressed, but re-dressing non repaired units with no additional material to be removed adds to the repair procedure. Perfect exactly matching heights is a desirable characteristic for all supports, but even where initial matched height is possible, it may be degraded due to damage in handling and use.

As a practical matter, users of vacuum supports should not be expected to closely inspect vacuum support heights after every job. Normally, when damage is discovered users must bear the expense of sending them out for refurbishment and re-calibration. Many of the problems with vacuum supports could be solved if they were more adequately protected from damage. Even if vacuum supports were more adequately protected, a level of damage still may occur that will render such supports not properly or safely usable. If this occurs, the user will generally have to keep whole replacement supports in stock, set the damaged support aside for shipment to have them re-built and re-dressed, or simply dispose of the damaged supports.

Needed improvements should synergize to reduce a user's overall cost and increase the user's overall options. A good improvement should begin by providing a support that is damage resistant to preferably withstand a high threshold of impact events that will not damage operations. Next, the improvement will enable a support that is damaged to be field repaired with replacement parts to enable a user to repair most types of damage to supports quickly and easily to return them to service. Still more preferable is the ability for ease of disassembly so that spare parts may be available both from spare parts stores and from partially damaged supports from which a repaired support may be derived.

### SUMMARY OF THE INVENTION

A prespecified height suction support with protective elastomeric overfit vacuum seal members and support members, hereafter “protected overfit vacuum support” of the invention, provides advantages yet unattained in the vacuum support industry. Such advantages include (1) a stable body for support that is closely toleranced to prespecifiable height, (2) upper and lower elastomeric overfit vacuum seal workpiece bearing members that are also closely toleranced to provide a prespecifiable height of support and that are damage resistant to protect the components of the stable body to which they are attached, (3) a general vertical bilateral support component symmetry to reduce the effective parts numbers, storage, and cost, (4) field replaceable parts with enhanced field repairability due to simplified construction, (5) a locking groove and slot as a part of the positive, easy fit and certain seal capabilities of the elastomeric overfit vacuum seal workpiece bearing members, (6) a design that promotes vacuum force full bearing support both with respect to the force that the elastomeric overfit vacuum seal workpiece bearing member exerts on the workpiece being supported, and with respect to the elastomeric overfit vacuum seal workpiece bearing member exerts on the stable body to insure its locked and vacuum fit onto the stable body, and (7) upper and lower peripheral surrounding lateral impact protection.

The combination of simplicity, duplication of components and tolerancing of components of the protected overfit vacuum support of the instant application gives an opportunity to provide five toleranced components into three types of components. If all of the components are acceptably tolerance controlled, the resulting assembly will be with an acceptable combined tolerance range. Two of the toleranced components relate to preferably identical first and second protective elastomeric overfit vacuum members. A structural assembly including a pair of preferably identical base plates connected together with non-vacuum support posts and at least one vacuum transmission support post provides the other three of the five toleranced components. The pair of preferably identical base plates connected together with non-vacuum support posts and at least one vacuum transmission support post may be referred to as a base plate and post structural assembly, and will contain the three structures, each of which can be manufactured to a tolerance and then assembled as a reliably tolerance controlled structure.

The protective elastomeric overfit vacuum members made of injection moldable thermoplastic or compression moldable rubber may have tolerances that are not as naturally controllable during part formation. Independent height tolerancing of the protective elastomeric overfit vacuum member will involve individual removal of material to a toleranced height for each such overfit vacuum member. The configuration of the protected overfit vacuum support is such that damage will most likely occur to one of the protective elastomeric overfit vacuum members. In most cases a damaged protective elastomeric overfit vacuum member can simply be manually removed from its base plate and post structural assembly and replaced with another protective elastomeric overfit vacuum member. The need to return a vacuum support to a manufacturer a structure that is required to be re-dressed and toleranced as a whole reconstructed whole unit at the factory is eliminated.

Because there are five vertical height structures, a vertical tolerance for each of these structures would only add up to a total tolerance that would be expected to be within the sum of the five tolerances for any given height of protected overfit vacuum support. Further, where each of the protective elastomeric overfit vacuum members experiences its own final support height adjustment from a flat vacuum machining jig, a precision combined height should be persistently reproducible. The flat vacuum machining jig uses a vacuum attraction from an underside of the protective elastomeric overfit vacuum member to the flat vacuum machining jig. This can create a powerful flattening attraction force similar to the one that the protective elastomeric overfit vacuum member will undergo when used with the protected overfit vacuum support base plate and under load. Thus, the working height of the finished protected overfit vacuum support should be faithfully produced and consistent with vacuum supported load conditions.

The protective elastomeric overfit vacuum member will support preferably a solid rubber seal. Many types of seals can be used, but solid rubber is expected to provide a more stable, more durable seal, long lasting seal. A rubber seal positioned to deform only slightly upon loading will result in a positive, vacuum tight seal throughout many cycles of use. The rubber seal works well whether it is provided as a continuous loop of material, or as a single length of material supported within a channel so as to have aligned abutting ends.

The protected overfit vacuum support supports the principles of inventory reduction and just-in-time component ordering. For a given area size of an assembled protected overfit vacuum support, the protective elastomeric overfit vacuum member and protected overfit vacuum support base plate are fixed. The posts that separate the protected overfit vacuum support base plate supporting the protective elastomeric overfit vacuum member are selected based upon the overall height desired for the vacuum support. Any height, tall or short, for the posts is possible so long as it is not so short that the vacuum fittings are inaccessible, and not so tall that a ratio of height to area plus lateral working force equate to a danger of tipping. For a given number of protected overfit vacuum support square sizes to be produced, a stock of popular lengths of posts may be maintained to have the ability to produce a variety of heights. This is the advantage of component multiplication within a given vacuum support device. The posts may be easily formed automatically as needed, and this will further reduce the need for stocks of parts.

The vertical bilateral symmetry of the protected overfit vacuum support means that it can be vertically reversed, although it is generally preferred to position vacuum support lines at a lower level to reduce any potential conflict with a working tool. The field replaceable parts and interchangeability of parts will turn a user's supply of assembled protected overfit vacuum supports into an alternative assembled storehouse of replacement parts. As an example, where two protected overfit vacuum supports have their upper protective elastomeric overfit vacuum member damaged by a rotating tool, perhaps through breakage of a workpiece, a user that would otherwise have two protected overfit vacuum supports removed from service can simply take an un-damaged lower protective elastomeric overfit vacuum member of one of the two damaged protected overfit vacuum supports and use it to replace the damaged upper protective elastomeric overfit vacuum member of the other support to then have a whole working un-damaged support. The same principles would apply if both the upper protective elastomeric overfit vacuum member and upper base plate of one protected overfit vacuum support were damaged, namely that an un-damaged lower base plate and un-damaged protected overfit vacuum support could be easily re-assembled as an upper protective elastomeric overfit vacuum member and upper base plate of the other protected overfit vacuum support. In this way, users can have a capacity to field repair their own protected overfit vacuum supports if, when and how they choose, with the purchase and storage of replacement parts only as they are needed when and if the user chooses to make-up any damaged protected overfit vacuum supports to a ready to use condition.

The mating of the locking groove of the base plate and protective elastomeric overfit vacuum member slot gives many advantages. The groove and slot provide an expanded area of sealing while providing a pushed insertion bullnose tight fit. The groove and slot enable a visual quick indication that the protective elastomeric overfit vacuum member is properly seated with respect to the base plate. At any point along the outer periphery, a break in seating is indicated by an irregularity in the outer protective vertical wall. Further, the location and direction of the groove and slot interlock encourages complete locking whenever a workpiece bears upon a protected overfit vacuum support. Such interlock is further encouraged when vacuum is provided to a side of the protected overfit vacuum support that is not completely seated and sealed. After seating, the groove and slot of the protected overfit vacuum support resist being unseated.

In terms of manufacturing, the protected overfit vacuum support of the instant application has a relatively straightforward manufacturing process. Once the horizontal area size, or “footprint” of the protected overfit vacuum support desired is known, a mold is made for the protective elastomeric overfit vacuum member corresponding to the size needed. The mold is filled with flexible rubber material of sufficient strength and a elastomeric overfit vacuum seal workpiece bearing member is formed. The elastomeric overfit vacuum seal workpiece bearing member is then “dressed” individually under support of a flat vacuum operable machining jig to form an independently toleranced member.

A base plate is formed using corresponding size details of interfit with the protective elastomeric overfit vacuum member. Then, depending on the height of support desired, posts of a given height are selected and used to joinably attach a pair of base plates together. A dressed protective elastomeric overfit vacuum member is then fitted to each of the base plates. Then a preferably rubber seal is placed in the seal channel of each of the two protective elastomeric overfit vacuum members, to then complete the assembly of the protected overfit vacuum support.

Instead of a formed single structure which is toleranced by dressing a particular combination of attached members by dressing one surface of the overall structure, each of the three main modular components that make up single protected overfit vacuum support are individually toleranced in order to have overall toleranced height control. The modularized nature of the assembly and the triple zone of independent tolerance limits is a consistent and complementary objective goal of the invention. Each of a first and a second protective elastomeric overfit vacuum seal workpiece bearing member is independently and individually brought to its own tolerance by independent dressing.

The non-elastomeric inner structural support, may be also known as a base plate and post structural assembly. The height tolerance of the components of the base plate and post structural assembly are each independently toleranced. The base plate and post structural assembly is made of two base plates of known thickness fixed and separated by sets of posts having highly exacting lengths. The resulting base plate and post structural assembly will have a pre-specified and controlled height tolerance which is the summing up of the individual height tolerances of its substituent components.

A good layout of vacuum supports for machining is usually a mix and match balance between larger supports that can occupy a main position underneath the workpiece, and smaller sizes that fill out the supported area nearer the periphery of the workpiece. Care must also be taken to consider the area of a support with regard to its height, both with respect to lateral stability and working machine limitations on height. Sizes for the protected overfit vacuum support of the instant application are expected to fall within popular ranges of sizes, including square protected overfit vacuum supports at sizes of 100 mm, 120 mm, 150 mm, 200 mm, & 250 mm square. Rectangular sizes for the protected overfit vacuum supports might be expected at 120 mm×150 mm, 150 mm×240 mm, 150 mm×300 mm, 150 mm×500 mm, 200 mm×300 mm, 200 mm×400 mm, and 250 mm×500 mm. Although any height of protected overfit vacuum support is possible, popular heights of 90 mm, 100 mm, 105 mm, 120 mm, 140 mm, 150 mm, 160 mm, 200 mm, and 240 mm may be expected. Round vacuum shapes are also possible and are expected to have sizes ranging from 65 mm to 300 mm in diameter. Other shapes of vacuum support of all sizes are also possible, such as triangular, pentagonal, hexagonal, custom shapes and the like. Further, complex shapes blending one or more of the aforementioned shapes are also possible.

### BRIEF DESCRIPTION OF THE DRAWINGS

The invention, its configuration, construction, and operation will be best further described in the following detailed description, taken in conjunction with the accompanying drawings in which:

FIG. 1 is a perspective view looking downward onto the height predetermined suction support with protective elastomeric overfit vacuum seal and support members connected to an upper and a lower vacuum support supply line and illustrating the upper elastomeric protrusion support pattern;

FIG. 2 is a perspective view looking downward onto the protected overfit vacuum support of the invention, similar to the view of FIG. 1, but with the upper and lower vacuum support lines removed to illustrate the vacuum fittings;

FIG. 3 is a view of the protected overfit vacuum support of the invention but with the upper and lower protective elastomeric overfit vacuum seals removed to reveal stepped base plates each having a lateral side locking groove;

FIG. 4 is an exploded perspective view of the vacuum support seen in FIGS. 1 & 2 emphasizing the vertical bilateral symmetry and a limited number of different types of components of construction;

FIG. 5 is a simplified plan exploded view of the protected overfit vacuum support structures seen in FIGS. 1-4 emphasizing detail of the vertical bilateral symmetry and side profile details of the upper and lower base plates;

FIG. 6 is a plan view of a top, workpiece engagement side of the protective elastomeric overfit member and illustrating the seal channel and locations of four vacuum transmission apertures;

FIG. 7 is a plan view similar in size and scale as FIG. 6 and illustrating an outline of a flexible seal shown in a configuration that corresponds to the size and orientation of the seal channel of the protective elastomeric overfit member seen in FIG. 6.

FIG. 8 is a plan view of a bottom, base plate bearing side of the protective elastomeric overfit member and illustrating areas of clear of lower projections at the locus adjacent vacuum transmission apertures that correspond to locations where a vacuum transmission screw may be located on the base plate;

FIG. 9 is an expanded plan view of a top side workpiece support and vacuum engagement first side of the protective elastomeric overfit member similar to that seen in FIG. 6;

FIG. 10 is a sectional view taken along line 10-10 of FIG. 9 including a connected magnifying view, and illustrating the arrangement of structures including top and bottom projections, seal channel and peripheral inwardly projecting locking rib projection of the protective elastomeric overfit member;

FIG. 11 is an elevational view of the of the exterior of the assembled protected overfit vacuum support of FIGS. 1-10 and shown with vacuum fittings in a position as seen in previous Figures;

FIG. 12 is a partial sectional view of the assembled protected overfit vacuum support taken along line 12-12 of

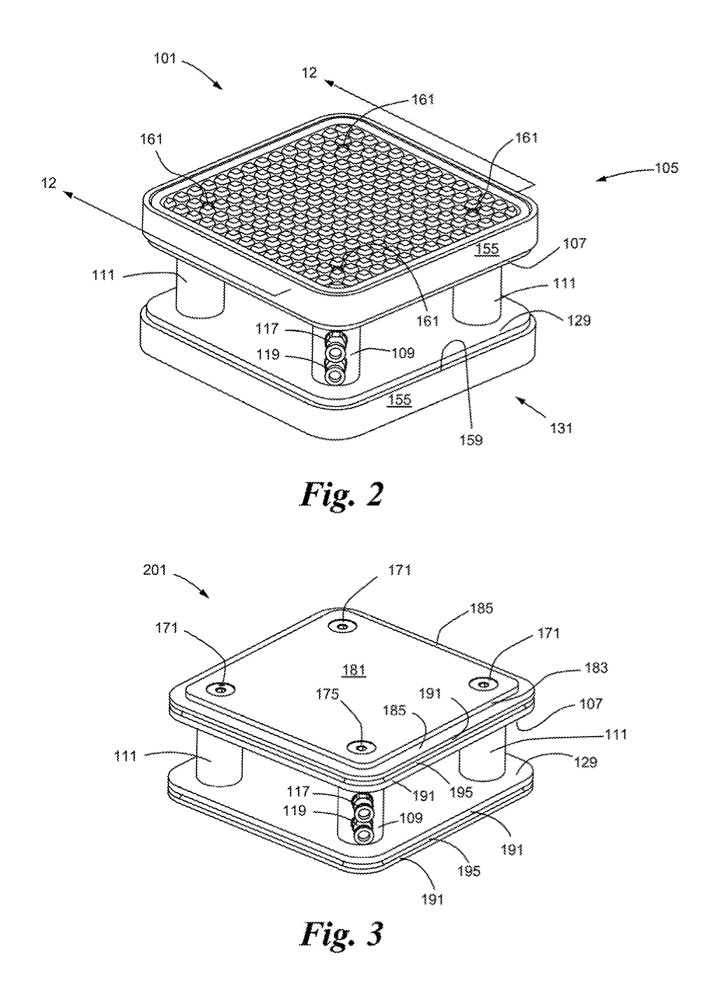

FIG. 2, but with the vacuum post and vacuum fittings turned at a right angle to the viewer to enable a more clear illustration of the vacuum path from the vacuum fittings through the vacuum post, vacuum transmission screws, and vacuum transmission apertures formed in the protective elastomeric overfit vacuum seal workpiece bearing member, as well as the non vacuum post and non vacuum transmission screws;

FIG. 13 is perspective view of a conic tool holder supporting an abrasive assembly used to remove material from the top of the protective overfit vacuum support to level it and enable a precise height of the protective overfit vacuum support in order to control the overall height of the prespecified height suction support with protective elastomeric overfit vacuum seal and support members;

FIG. 14 is a lower perspective view of the conic tool holder of FIG. 13 and exposing more of a bottom view and details of the underside conic edge of the abrasive material;

FIG. 15 illustrates a perspective view of a top side workpiece support adjacent a base plate shaped machining support base used to stabilize and vacuum down the protective elastomeric overfit member in a position and under conditions as nearly exactly closely as it would occupy in vacuum support service, the machining support base to supply support to enable the vacuum engagement side of the protective elastomeric overfit member support projections to be abraded to an evenly flat profile;

FIG. 16 illustrates a perspective view of a spindle drive, including the abrasive of FIGS. 13 and 14, indicated as rotating while moving over the top side of the protective elastomeric overfit member of FIG. 15 as it is supported by the base plate shaped machining support base of FIG. 15;

FIG. 17 is a side plan view of the predetermined height suction support with protective elastomeric overfit vacuum seal and support members, supporting a workpiece with respect to a table support; and

FIG. 18 is a perspective downward looking view illustrating multiple arranged numbers of the predetermined height suction support with protective elastomeric overfit vacuum seal and support members jointly supporting a workpiece from a working table, the workpiece shown transparently, FIG. 18 including a magnified expanded view portion.

### DETAILED DESCRIPTION OF THE PREFERRED EMBODIMENT

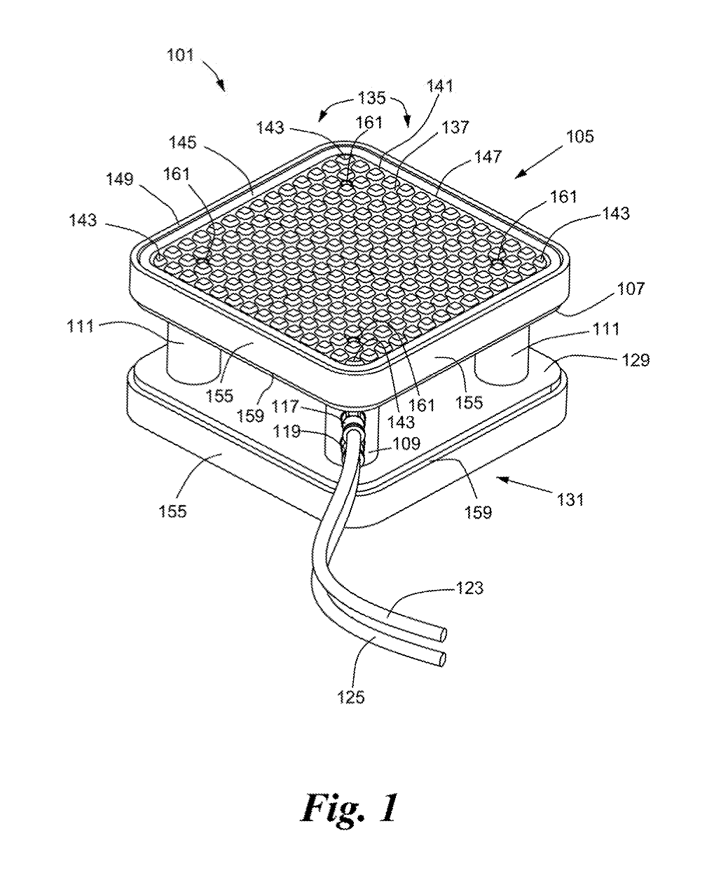

Referring to FIG. 1, a square shaped predetermined height suction support with protective elastomeric overfit vacuum seal and support members is seen as a protected overfit vacuum support 101. Protected overfit vacuum support 101 is seen looking downward onto an upper first side of a protective elastomeric overfit vacuum seal workpiece bearing member 105. In FIG. 1, a first upper, workpiece bearing side is predominantly seen. Only a portion of upper base plate 107 is, from the perspective of FIG. 1, seen immediately beneath the bearing member 105.

A vacuum post 109 is seen along with support posts 111, two of which are seen and one located at a far corner of the square protected overfit vacuum support 101 and one of the support posts 111 is not readily visible in FIG. 1. Vacuum post 109 has an upper pneumatic vacuum fitting 117 and a lower pneumatic vacuum fitting 119. An upper vacuum supply tube 123 is shown connected to an upper pneumatic vacuum fitting 117, and a lower vacuum supply tube 125 is shown connected to a lower pneumatic vacuum fitting 119.

Preferably the pneumatic vacuum fittings 117 and 119 will generally be located at a relatively lower position on vacuum post 109 within a reasonable position to enable vacuum post 109 to have stable strength and support while enabling a relatively low and appropriately sufficiently separated vacuum fittings 117 and 119 shown in the lower portion of the post. A vacuum post 109 having a diameter of about one and one quarter inches works well. Absent the pneumatic vacuum fittings 117 and 119, the protected overfit vacuum support 101 has a general vertical bilateral symmetry. However, the pneumatic vacuum fittings 117 and 119 will typically be located near the bottom of the vacuum post 109 to help keep the upper and lower vacuum supply tubes 123 & 125 in a lower position to reduce the probability of inadvertent contact with other objects such as rotating tools.

A lower base plate 129 is attached to the bottom of the posts 107 and 109. Attached to the lower base plate 129 is a lower protective elastomeric overfit vacuum seal workpiece bearing member 131 which is preferably identical to upper protective elastomeric overfit vacuum seal workpiece bearing member 105. In some cases a protected overfit vacuum support 101 may be manufactured with a bottom shape different than a top shape. This may be advantageous for specialized support jobs or situations with other restrictive spacing. In nearly all other instances, the upper and lower base plates 107 and 129 are expected to be exactly the same. Further, upper and lower protective elastomeric overfit vacuum seal workpiece bearing members 105 and 131 are similarly expected to be exactly the same where the upper and lower base plates 107 and 129 are exactly the same.

But for a choice to locate the pneumatic vacuum fittings 117 and 119 relatively low, and but for the presence of the fittings 117 and 119, the protected overfit vacuum support 101 has bilateral symmetry about a horizontal plane. This contributes greatly to a common modularity and reduction of the different types of components necessary to construct the protected overfit vacuum support 101. The area footprint desired determines the size of base plate 107 and 129, as well as the area and other dimensions of the lower protective elastomeric overfit vacuum seal workpiece bearing member 105 and 131. The selection of the height of the posts 109 and 111 will determine the overall height of the protected overfit vacuum support 101.

An infinite number of shapes for the protected overfit vacuum support 101 is possible. As can be seen in FIG. 1, only about 5 millimeters height of the upper and lower base plates 107 and 129 are laterally exposed (not covered) and thus the upper and lower base plates 107 and 129 are well protected. The top and bottom of the protected overfit vacuum support 101 are protected from inadvertent impact damage by the elastomeric overfit vacuum seal workpiece bearing members 105 & 131. For any given shape, an infinite number of heights can be formed by selecting different lengths of support posts 111 and a vacuum post 109.

Initial details of the elastomeric overfit vacuum seal workpiece bearing members 105 & 131 are best explained beginning with workpiece bearing member 105 as it is best seen in FIG. 1. For consistent reference, the upper workpiece bearing member 105 shows a top side workpiece engagement support and vacuum engagement side 135 most prominently and from an upward vantage point. The main middle area of the side 135 of the upper workpiece bearing member 105 has a floor 137 from which a series of generally uniform vertically upwardly directed, four-sided, curved edge, outwardly bowed base, frusto-pyramidal projections 141 form a substantially even pattern.

The frusto-pyramidal projections 141 are generally evenly distributed along the edges of the floor 137. However, nearest each of the corners of the workpiece bearing members 105 a modified projection 143 has two of its four sides even further modified into an arcing curvature both for aesthetics and to insure that no partial projections 141 or 143 are present near an outside boundary of a floor 137 where interference might occur with another structure. The incline of each of the walls of the projections 141 and 143 is about thirty degrees from perpendicular normal to the first side 135.

At the base of the projections 141 and 143 the floor 137 width between adjacent projections 141 and 143 is about three millimeters. The regular projections 141 have a maximum base width from bowed curved base side to bowed curved base side of about eight and three quarter millimeters. The un-dressed height of the regular projections may be about two and a half millimeters and the width of the un-dressed top of the projections may be about six and a half millimeters from bowed curved upper edge to bowed curved upper edge. After height adjustment “dressing”, the projections 141 will be shorter and the flat upper surface of the projections 141 will be slightly wider and with slightly more area than when not yet dressed.

A seal 145 is seen adjacent an edge 147 of the floor 137. Adjacent the outside of the seal 145 an upper rim 149 is seen. Structures between the inner edge of the floor 137, and upper rim 149 (not shown in FIG. 1) support the sides and bottom of the seal 145. A vertical wall 155 is seen on upper protective elastomeric overfit vacuum member 105 and on lower protective elastomeric overfit vacuum member 131. As seen from the upper protective elastomeric overfit vacuum member 105 upper rim 149, the vertical wall 155 extends downwardly to a lower rim 159. Lower rim 159, however, is best seen on the lower protective elastomeric overfit vacuum member 131.

In FIG. 1, the area of the vertical wall 155 at or near the lower rim 159 visually indicates locking. In FIG. 1, the vertical wall 155 is smooth and flat against the base plates 107 and 129 to indicate locking. There are a series of four vacuum transmission apertures 161 located inboard of the four corners of the upper protective elastomeric overfit vacuum seal workpiece bearing member 105. During manufacture and assembly, or upon removal and replacement of either of the protective elastomeric overfit vacuum seal workpiece bearing member 105 and 131 onto upper or lower base 107 and 129, and regardless of which of the four ways that a square structure can be positioned, one of the four vacuum transmission apertures 161 will always be positioned over the vacuum post 109 to insure that a source of vacuum is available above and below the floor 137.

Referring to FIG. 2, a perspective view looking downward onto the upper protective elastomeric overfit vacuum seal workpiece bearing member 105 shows the upper and lower vacuum support lines 123 & 125 removed. Each vertical wall 155 of the upper and lower protective elastomeric overfit vacuum seal workpiece bearing members 105 and 131 is seen to lie flat and linear against their respective upper and lower base plates 107 and 129. Removal of the upper and lower protective elastomeric overfit vacuum seal workpiece bearing members 105 and 131 is accomplished by manually engaging the lower rim 159 of the vertical wall 155 and urging it out, and up from its respective upper or lower base plates 107 or 129.

Curling the fingers over an upper rim 149 and vertical wall 155 and engaging the lower rim 159 with the tips of the fingers and/or fingernails requires only a slight amount of manual strength. A lifting pressure will cause the top protective elastomeric overfit vacuum seal workpiece bearing member 105 or 131 so grasped to be easily removed. The mechanism is much like certain food containers in which a manual disconnection of a portion of a continuous circumferential seal engagement leverages the ease of disengagement of the remainder of the seal.

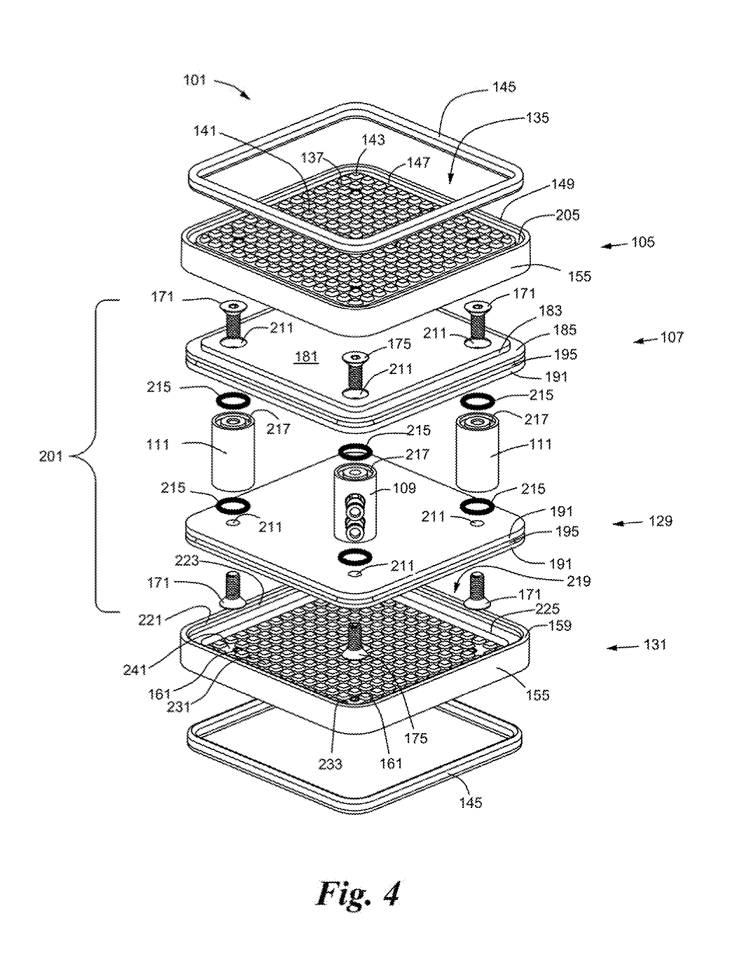

Referring to FIG. 3, a view of the vacuum support of the invention is shown in the same orientation as FIG. 2, but with upper and lower protective elastomeric overfit vacuum seal workpiece bearing members 105 and 131 removed to better show underlying details. Upper base plate 107 is more fully exposed and several features are seen. The upper base plate 107 is secured by a series of non-vacuum transmission internal hex screws 171 and a vacuum transmission internal hex screw 175. The vacuum transmission internal hex screw 175 is modified with a small central bore to allow vacuum to be transmitted from upper pneumatic vacuum fitting 117 though the internal hex wrench opening through the center of the vacuum transmission internal hex screw 175.

Upper base plate 107 has a central flat surface 181. At the perimeter of central flat surface 181, a step includes a brief vertical wall 183 leading to lower perimeter surface 185 surrounding the central flat surface 181. A vertical wall section 191 surrounding the lower perimeter surface 185 is interrupted by a peripherally outwardly directed channel 195. The channel 195 may be slightly above the center of the vertical wall section 191 to make removal and replacement of the upper protective elastomeric overfit vacuum seal workpiece bearing member 105 slightly easier, as will be shown.

The vertical wall section 191 and peripherally outwardly directed channel 195 is also seen on the lower base plate 129, which may be preferably identical to upper base plate 107. The combined assembly of FIG. 3 that includes the upper and lower base plates 107 and 129 and the posts 111 and 109 joining them together with the screws 171 and 175, may be referred to as a base plate and post structural assembly 201.

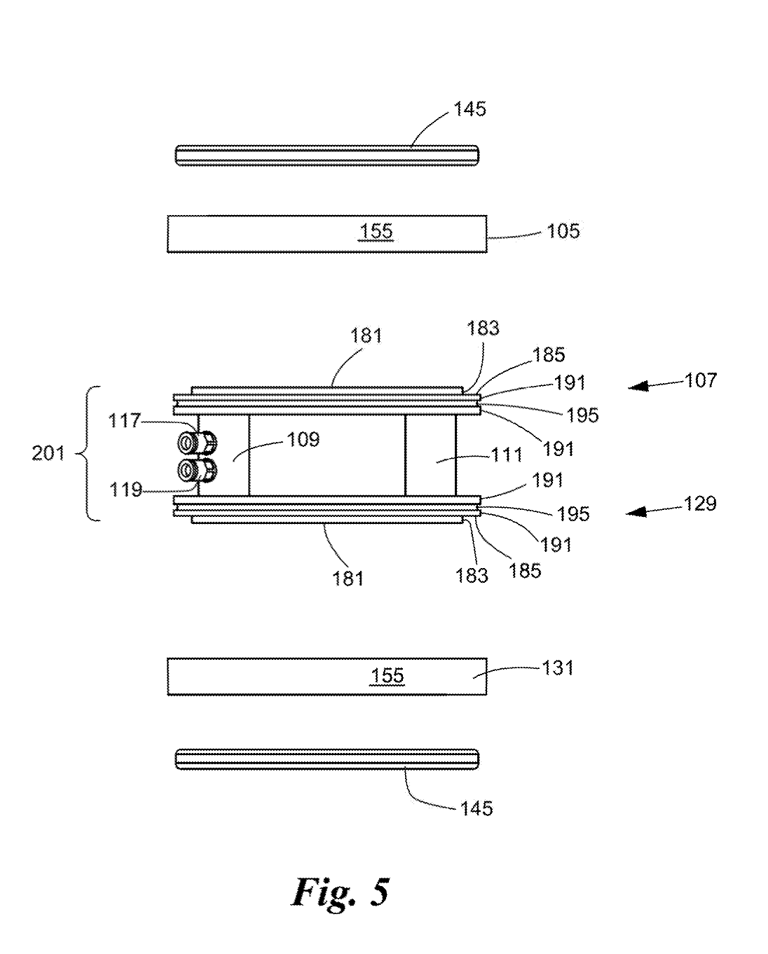

Referring to FIG. 4, an exploded perspective view of the protective elastomeric overfit vacuum seal and support members is seen as a protected overfit vacuum support 101 of FIGS. 1 & 2 is seen. The base plate and post structural assembly 201 is shown and identified. At the top, the seal 145 is shown as a continuous loop, but this need not be the case. Seal 145 can be molded as a single piece, or it can be extruded, cut, and the ends glued or solvent welded together. Actually, because the seal is vertically deep enough to be well supported by the upper protective elastomeric overfit vacuum seal workpiece bearing member 105, and because the vacuum applied is of sufficiently high magnitude, the ends of single length of seal material with flat ends could simply be brought into abutment in order to form a sufficient air flow obstruction. Further sealing is also aided especially where the material is axially compressed slightly by stuffing it into its resting support position.

A seal channel 205 is seen within the upper protective elastomeric overfit vacuum seal workpiece bearing member 105 within the wall upper rim 149 which forms the resting support position for the seal 145. Below the screws 171 and 175, the upper base plate 107 is seen to have chamfered apertures 211 through which the screws 171 and 175 will fit when engaged with the posts 109 and 111, provide the flat profile seen in FIG. 3. Below the upper base plate 107, and above and below posts 109 and 111 are seen a number of “o” rings 215. The posts 109 and 111 each have two ends. Each end has a single “o” ring support 217 (only one end of three of four of the supports are seen in FIG. 4).

Beneath the posts 109 and 111, the lower base plate 129 reveals the non-chamfered side of the openings of the chamfered apertures 211. The area around the smaller openings of the chamfered apertures 211 is generally flat, as is the same for identical upper base plate 107. The “o” rings 215 that protrude from the “o” ring support 217 will seal against the expansive flat surfaces of the upper and lower base plates 107 and 129 on their facing sides between which the posts 109 and 111 will support and separate. The attachment of the posts 109 and 111 using the screws 171 and 175 to both of the oppositely oriented upper and lower base plates 107 and 129 will seal against any leakage in vacuum at the interface between upper and lower base plates 107 and 129, and the posts 109 and 111.

Beneath lower base plate 129 a first view of a second, or underside of the lower protective elastomeric overfit vacuum seal workpiece bearing member 131 is seen as a workpiece engagement support and vacuum engagement second side 219. Workpiece engagement support and vacuum engagement second side 219 includes some structures seen in the Figures for the first time. From a planar portion of the lower rim 159, a radiused groove engagement projection 221 begins its radius turn upward to form a continuous radially inwardly disposed half cylindrical projection nearest the lowermost part of the upper protective elastomeric overfit vacuum seal workpiece bearing member 105, and in the opposite direction from the lowest part of the vertical wall 155.

The shape and depth of the peripherally outwardly directed channel 195 matches and interfits with the a radiused groove engagement projection 221. The lower most placement of the projection 221 will enable the bearing member 105 to be most easily disengaged from the upper base plate 107, and it cause a visual signal of any discontinuity of engagement of the projection 221 with respect to the peripherally outwardly directed channel 195 of projection 221. The lowest most placement of the projection 221 also enables an easy manual separation to begin the process of manual removal of the upper protective elastomeric overfit vacuum seal workpiece bearing member 105 from the upper base plate 107.

A brief inside wall 223 lies adjacent the groove projection 221. Adjacent the inside wall 223 a seal channel structure 225 is an amount of material provided to accommodate seal channel 205 of the first side of the lower protective elastomeric overfit vacuum seal workpiece bearing member 131. Seal channel structure 225 includes structure that contributes to both the bottom and a side wall of the seal channel 205. Adjacent the seal channel structure 225, a series of “underside” projections 231 project above an underside floor 233 on the second side (non workpiece bearing side) of the lower protective elastomeric overfit vacuum seal workpiece bearing member 131 may be the same or different than the “bearing side” projections 141 of the first side of the lower protective elastomeric overfit vacuum seal workpiece bearing member 131 (not seen in FIG. 4 but which are seen with respect to the upper protective elastomeric overfit vacuum seal workpiece bearing member 105).

Note that the projections 231 on the non-workpiece bearing second side will not be “dressed” or leveled. The projections 231 as they lie against central flat surface 181 of either the upper or lower base plate 107 and 129 create a matrix pattern of vacuum distribution channels made up of the sides of the projections 231, the “underside” or second side floor 233, and the central flat surface 181 lower base plate 129. Given that a source of vacuum is transmitted through a relatively small internal hex opening of a single vacuum transmission internal hex screw 175, a missing projection space 241 is provided on the second side of preferably identical upper and lower protective elastomeric overfit vacuum seal workpiece bearing members 105 and 131 in a position adjacent each of the series of four vacuum transmission apertures 161 to assure elimination of any blocking structure.

Missing projection space 241 is in a location overlying the area above or below the vacuum transmission internal hex screw 175 when the upper and lower protective elastomeric overfit vacuum seal workpiece bearing members 105 and 131 are fitted onto the upper or lower base plate 107 and 129 of the base plate and post structural assembly 201. The missing projection space 241 insures that the upper opening of the vacuum transmission internal hex screw 175 will not be even partially blocked. Thus, each of the identical protective elastomeric overfit vacuum seal workpiece bearing members 105 and 131 are provided with four vacuum transmission apertures 161 and four missing projection space 241 in order that the four orientations of fit onto the base plates 107 and 129 will equally facilitate the transmission of vacuum both for the first and second sides of preferably identical upper and lower protective elastomeric overfit vacuum seal workpiece bearing members 105 and 131.

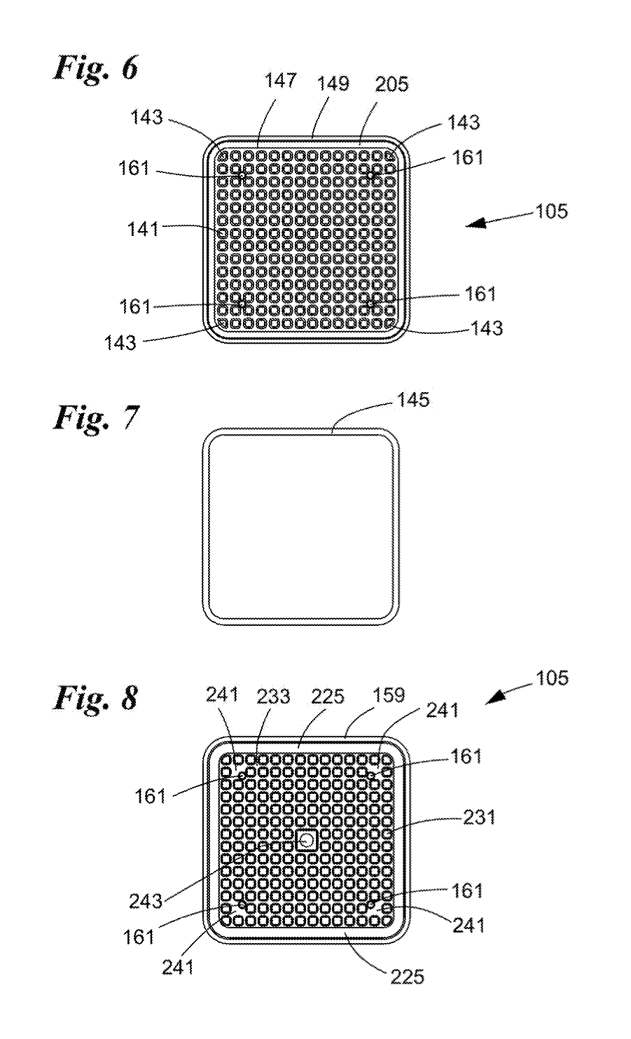

Referring to FIG. 5, a simplified plan exploded view of protected overfit vacuum support 101 as seen in FIGS. 1-4 provides a clearer view of lateral detail. The relationship of the vertical wall section 191 and the peripherally outwardly directed channel 195 is more clearly seen. FIG. 5 also illustrates the component parts of the protected overfit vacuum support 101 that can be disassembled manually, without tools. It is expected that most of the repairs will involve replacement of the seal 145 or the preferably identical upper and lower protective elastomeric overfit vacuum seal workpiece bearing members 105 and 131.

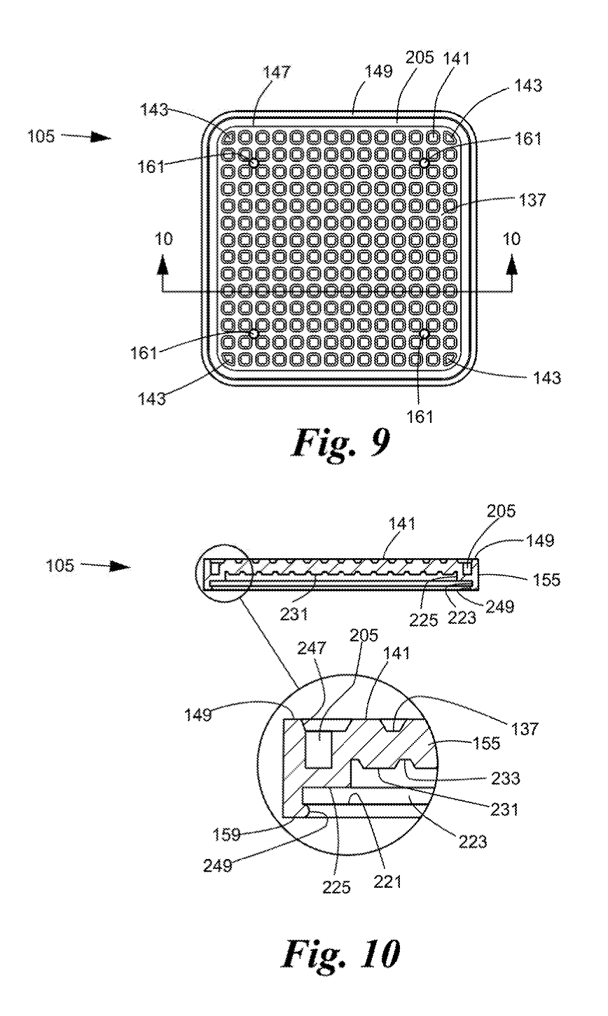

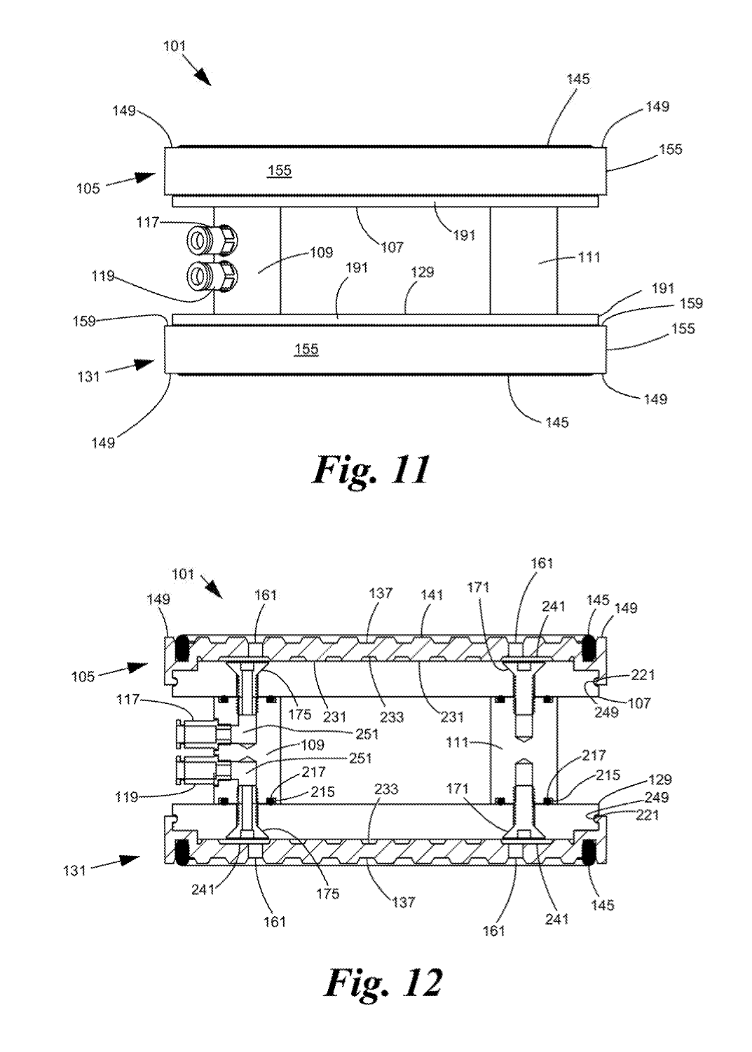

Referring to FIG. 6, a plan view of a first, top side, of the upper protective elastomeric overfit vacuum seal workpiece bearing member 105 is shown. The seal channel 205 and edge 147 of floor 137 are more clearly seen. The location of the series of four vacuum transmission apertures 161 with respect to the corner adjacent modified projections 143 are better viewed. Referring to FIG. 7, a plan view of the seal 145 is shown with a shape, size, and orientation configured to fit within seal channel 205 of FIG. 6.

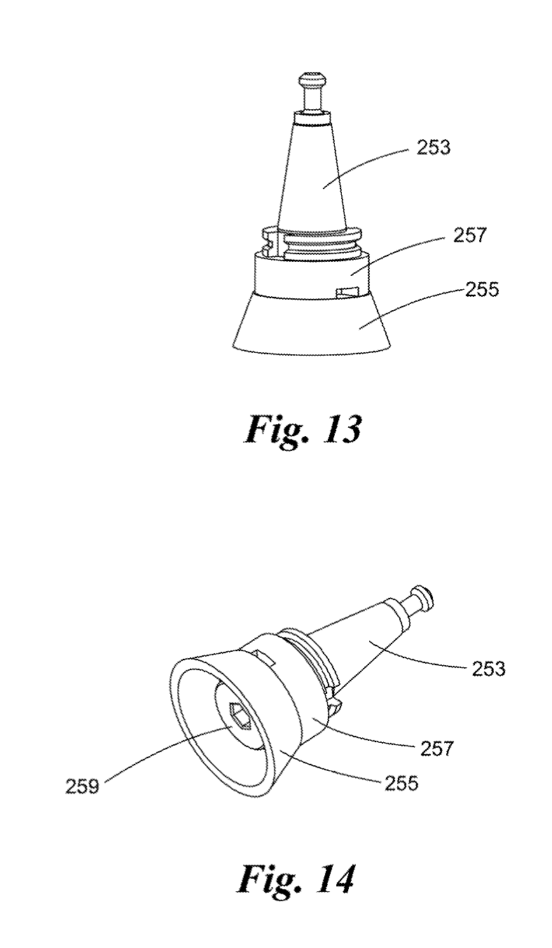

Referring to FIG. 8, a plan view of a second, underside of the upper protective elastomeric overfit vacuum seal workpiece bearing member 105 is shown. For the first time a molding injection area 243 is clearly seen as an expected disruption to the second side or “underside” projections 231. Molding injection area 243 may be necessary depending upon the orientation of the injection mold, but as shown, only four of the projections 231 are eliminated and the centered nature of the molding injection area 243 helps to minimize any performance effects on the protected overfit vacuum support 101. Also more clearly seen is the relationship between series of four vacuum transmission apertures 161 and their associated missing projection spaces 241.

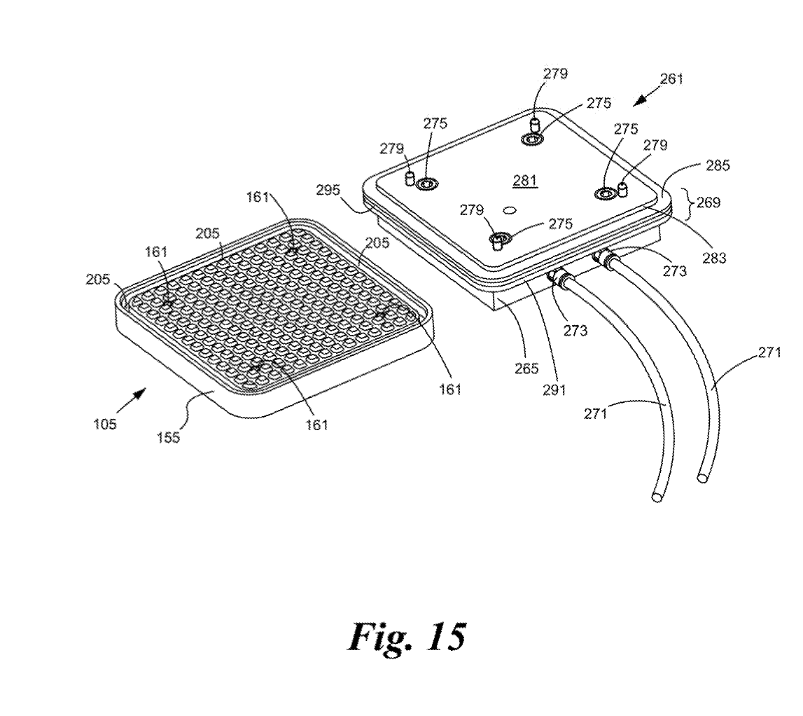

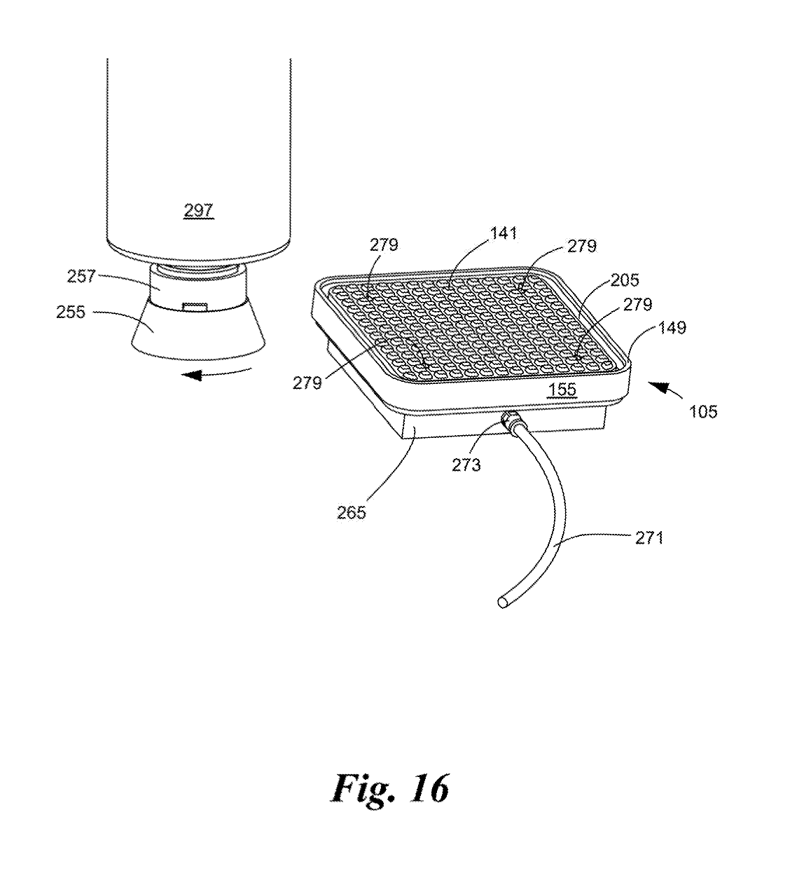

Referring to FIG. 9, an expanded plan view of the first top side of the upper protective elastomeric overfit vacuum seal workpiece bearing member 105 gives a little clearer view of the spatial relationships of the structures seen in FIG. 6. Referring to FIG. 10, a sectional view taken along line 10-10 of FIG. 9 enables illustrating more clearly the arrangement of structures seen in FIGS. 1-9, especially as oriented in a registered alignment with FIG. 9 and includes a connected magnified view. Seen for the first time is an angled transition 247 between the upper rim 149 and a wall portion of the seal channel 205. This serves the purpose of providing some room for a solid rubber seal to displace when the protected overfit vacuum support 101 is under load causing the seal to be load displaced.

The first side projections 141 need not have a matching mirror correspondence with the projections 231. The floor widths of the first floor 137 and second floor 233 may, but need not match. A floor width between projections 141 or 231 of about three millimeters may suffice for floors 137 and 233. As previously mentioned the first side projections 141 should be molded with an expected height of material sufficient to allow it to have material removal under vacuum to a level of toleranced flatness. As can be seen, the projections 141 are slightly higher than the projections 231 as the projections 141 will experience material removal during dressing. One height that has worked well for the projections 141 is a height of about two and a half millimeters while the projections 231 have a height of about two millimeters. One dimension that has worked well for the separation of the projections 231 is a midline base to base dimension (along floor 233) of about three millimeters. This allows vacuum to be quickly transmitted throughout the part once the perimeter is sealed.

A depth of seal channel 205 that has worked well is about six millimeters by 12 millimeters. The angle of the angled transition 247 is expected to be about the same as the angle of the walls of the projections 141 and 143 at about thirty degrees from perpendicular normal of the first side 135.

The thickness of support material surrounding the seal channel 205, even where shared with other structures is a little less than about two tenths of an inch and may vary depending upon the size of seal 145 and other factors. The groove projection 221 works well with a distance of protrusion from brief inside wall 223 of about one and a half millimeters. This includes a radiused innermost extent 249 having a radius of about sixty two and a half thousandths of an inch. The innermost extent of the peripherally outwardly directed channel 195 will preferably be ideally matched to the groove projection 221.

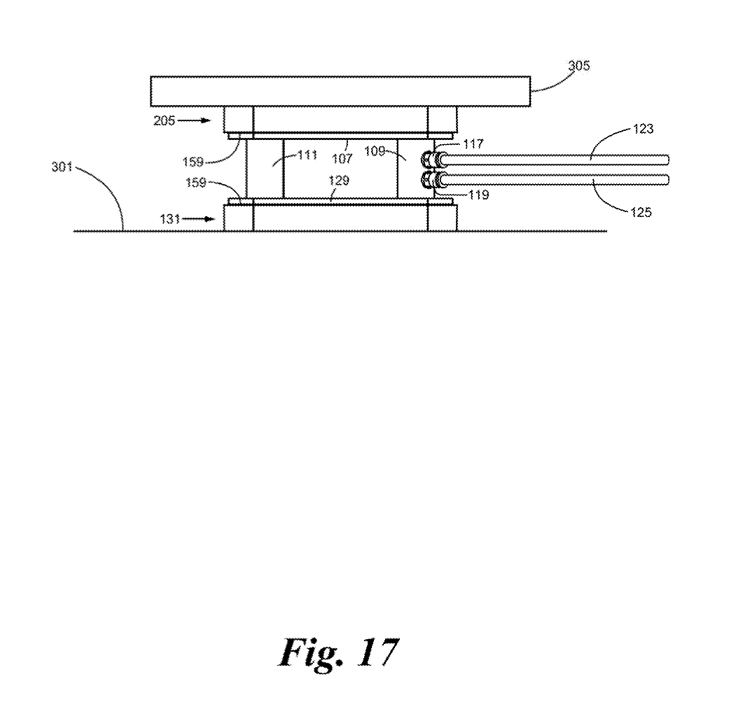

Referring to FIG. 11, an elevational view of the assembled protected overfit vacuum support 101, of FIGS. 1-10, illustrates a side profile view including the vacuum post 109 and vacuum fittings 117 and 119 shown at an angle to the viewer, consistent with the views shown in the previous Figures. The uppermost portion of seal 145 is seen only very slightly above the projections 141 and the upper rim 149 (as the projections 141 and upper rim 149 will be the same height after dressing the upper protective elastomeric overfit vacuum seal workpiece bearing member 105).

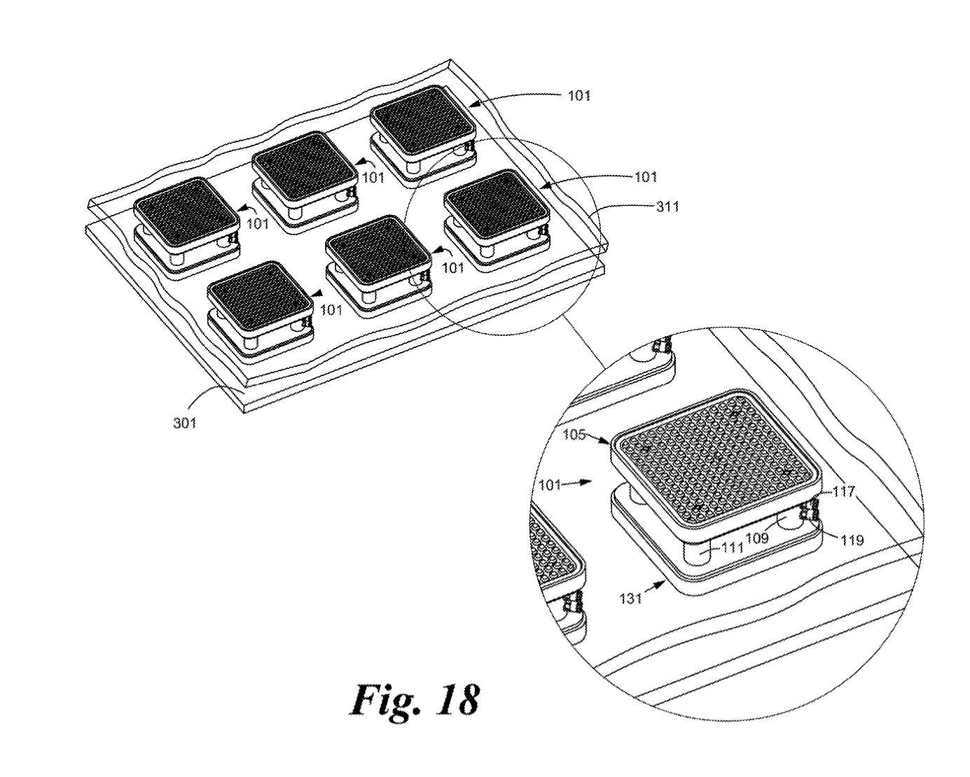

Referring to FIG. 12, a sectional view of the assembled protected overfit vacuum support 101, taken along line 12-12 of FIG. 2, is shown with vacuum post 109 and vacuum fittings 117 and 119 turned at a right angle to the viewer to enable illustration of the vacuum path. From the vacuum fittings 117 & 119, the vacuum is transmitted through a vacuum passage 251, the vacuum post 109, vacuum transmission internal hex screws 175, and vacuum transmission apertures 161 and through to communication with the top side floor 137 of the protective elastomeric overfit vacuum seal workpiece bearing member 105. The non-vacuum post 111 and non-vacuum transmission screws 171 are also illustrated for comparison.

The post engaging non-vacuum screws 171 under vacuum transmission aperture 161 and missing projection space 241 illustrates the role that these structures play in equalizing vacuum on both sides of the upper and lower protective elastomeric overfit vacuum seal workpiece bearing members 105 and 131. Post engaging non-vacuum screws 175 do not supply vacuum. However vacuum transmission aperture 161 and missing projection space 241 are structures that further distribute vacuum between both sides of the upper and lower protective elastomeric overfit vacuum seal workpiece bearing members 105 and 131. FIGS. 11 and 12 both illustrate the linear nature of the vertical wall 155 at the side of the upper and lower protective elastomeric overfit vacuum seal workpiece bearing members 105 and 131 when groove projection 221 is properly seated in the peripherally outwardly directed channel 195. Also, seal 145 is seen in cross section as having curved upper and lower sides and supported by the seal channel 205 having right angled corners to provide space for the seal 145 to displace.

Referring to FIG. 13, perspective view of a conic tool holder 253 further supporting an abrasive body 255 with an assisting collar structure 257. Abrasive body 255 is preferably used to remove material from the flat upper rim 149 which lies adjacent the top vertical wall 155, and from the frusto-pyramidal projections 141. Flat upper rim 149 and frusto-pyramidal projections 141 will preferably be formed to start at a same height and preferably will be dressed simultaneously.

Referring to FIG. 14, a lower perspective view of conic tool holder 253 abrasive body 255 illustrates a locking nut 259 used to hold the assisting collar structure 257 and abrasive body 255. The conical shape and planar underside of the abrasive body 255 facilitates its use in a lateral motion while spinning to effect material removal. The device of FIGS. 13 and 14 are but one of many configurations used to dress the upper protective elastomeric overfit vacuum seal workpiece bearing member 105 while it is stably supported. The upper protective elastomeric overfit vacuum seal workpiece bearing member 105 is preferably identical with respect to lower protective elastomeric overfit vacuum seal workpiece bearing member 131, and either or both is expected to be produced in the same manner.

Referring to FIG. 15 a perspective view of the upper protective elastomeric overfit vacuum seal workpiece bearing member 105 that is ready to load onto a specialized vacuum dressing support 261 shown adjacent. The upper protective elastomeric overfit vacuum seal workpiece bearing member 105 will have been produced by molding, with the four vacuum transmission apertures 161 having been formed during or after molding. A specialized vacuum dressing support 261 includes a base 265 which can facilitate stable support from a working table in any number of ways. Some of the ways (not shown) that the base 265 might derive support might include an independent vacuum hold down, mechanical fixation, bolting down, a repeatable quick change fixture, a pallet chuck, and the like. The base 265 supports a fixture 269 which is the size and shape of the upper base plate 107 (and which is preferably identical to the lower base plate 129) with a few exceptions.

Base 265 is fed by a vacuum supply hose 271 through a fitting 273, to provide a hold down vacuum. The upper protective elastomeric overfit vacuum seal workpiece bearing member 105 must be held down based solely on the vacuum supplied to its underside spaces and in the absence of a seal 145 and any upper engagement it might otherwise have. The vacuum is applied into the base 265 through the fixture 269 by a series of vacuum supply bores 276. Due to the underside projections 231 (not seen in FIG. 15) a vacuum applied at a single location bore 275 will be distributed across the bottom of the upper protective elastomeric overfit vacuum seal workpiece bearing member 105. However, four vacuum supply bores 276 help supply assurance of even vacuum hold down during the dressing operation.

The series of four vacuum transmission apertures 161 of the upper protective elastomeric overfit vacuum seal workpiece bearing member 105 will be blocked by four short height pins 279. Each one of the four short height pins 279 fits into an associated one of the four vacuum transmission apertures 161. The fit of the four short height pins 279 into the four vacuum transmission apertures 161 should be at least slightly snug to “plug” any leakage of air. The four short height pins 279 will each block any air that would otherwise pass through any of the apertures to break a hold down vacuum that will keep the upper protective elastomeric overfit vacuum seal workpiece bearing member 105 flat against a flat surface 281 of the fixture 269 of the specialized vacuum dressing support 261.

Other exterior shape features of the fixture 269 should be very similar to the features of the upper base plate 107. By example, the exterior features of fixture 269 include a central fixture flat surface 281, a brief fixture vertical wall 283, a lower fixture perimeter surface 285, a fixture vertical wall section 291, and a peripherally outwardly directed fixture channel 295. The upper protective elastomeric overfit vacuum seal workpiece bearing member 105 is loaded onto the fixture 269 with the four vacuum transmission apertures 161 fitted over the four short height pins 279, and with the groove projection 221 fitted into the peripherally outwardly directed fixture channel 295 about the perimeter of the fixture 269.

Referring to FIG. 16, the upper protective elastomeric overfit vacuum seal workpiece bearing member 105 is shown in place atop the fixture 269. A conic tool holder spindle drive motor 297 rotates the assisting collar structure 257 and abrasive body 255 at high speed as the motor is made to pass over the vacuum stabilized upper protective elastomeric overfit vacuum seal workpiece bearing member 105 to level and remove material from the upper rim 149 adjacent the vertical wall 155 and the frusto-pyramidal projections 141 simultaneously to “dress” the upper protective elastomeric overfit vacuum seal workpiece bearing member 105 to the desired toleranced height. This will allow protected overfit vacuum support 101 to be assembled to a predictable toleranced height.

Referring to FIG. 17, is a side plan view of the protected overfit vacuum support 101 shown in place atop a working table 301 and supporting a workpiece 305. Vacuum applied through the lower pneumatic vacuum fitting 119 anchors the protected overfit vacuum support 101 to the working table 301. Vacuum applied through the upper pneumatic vacuum fitting 117 anchors the workpiece 305 to the protected overfit vacuum support 101.

Referring to FIG. 18, a perspective downward looking view onto a working table 301 having a number of protected overfit vacuum supports 101 located in a pattern about table 301. An expanded view of a corner of the table 301 is also shown for detail. Protected overfit vacuum supports 101 are in a position to adequately support a large workpiece shown as a clear, see-through material 311 in order to see the pattern of protected overfit vacuum supports 101. For simplicity, upper and lower vacuum supply tubes 123 and 125 are not present. In addition, so long as the heights match, the protected overfit vacuum supports 101 can be used alongside conventional vacuum supports, so that it may be possible to have a more gradual adoption of the protected overfit vacuum supports 101.

While the present invention has been described in terms of a vacuum support structure and manufacturing method for producing a protected overfit vacuum support having protective elastomeric overfit vacuum seal members and support members, the structures techniques employed herein are applicable to a wide range of devices, machines, and methods to provide easily producible, assemblable and field repairable vacuum supports, and including tolerancing for field replaceability of components. Although the invention has been derived with reference to particular illustrative embodiments thereof, many changes and modifications of the invention may become apparent to those skilled in the art without departing from the spirit and scope of the invention. Therefore, included within the patent warranted are all such changes and modifications as may reasonably and properly be included within the scope of this contribution to the art.

What is claimed:

1. A vacuum support for supporting a workpiece, comprising:
a base plate and post structural assembly including a first and a second oppositely disposed base plate supported with respect to each other by attachment to a plurality of support posts;
a first protective elastomeric overfit vacuum seal workpiece bearing member having a first side and a second side attached to the first base plate;
a first perimeter seal carried by the first protective elastomeric overfit vacuum seal workpiece bearing member;
a second protective elastomeric overfit vacuum seal workpiece bearing member having a first side and a second side attached to the second base plate;
a second perimeter seal carried by the second protective elastomeric overfit vacuum seal workpiece bearing member; and
a vacuum transmission structure for providing vacuum to the first sides of the first and second protective elastomeric overfit vacuum seal workpiece bearing members.

2. The vacuum support for supporting a workpiece as recited in claim 1, wherein the vacuum transmission structure is located, on and transmits vacuum through at least one of the plurality of support posts.

3. The vacuum support for supporting a workpiece as recited in claim 2, wherein the vacuum transmission structure further comprises a first vacuum fitting carried by the one of the plurality of support posts, a first vacuum passage in communication with the vacuum fitting, and a vacuum transmission screw in communication with the first vacuum passage and with the second side of a first protective elastomeric overfit vacuum seal workpiece bearing member at the second side of the first base plate.

4. The vacuum support for supporting a workpiece as recited in claim 3, wherein the vacuum transmission structure further comprises a second vacuum fitting also carried by the one of the plurality of support posts, a second vacuum passage in communication with the second vacuum fitting, and a vacuum transmission screw in communication with the second vacuum passage and with the second side of a second protective elastomeric overfit vacuum seal workpiece bearing member at the second side of the second base plate.

5. The vacuum support for supporting a workpiece as recited in claim 1, wherein the first and a second perimeter seals carried by their respective first and second protective elastomeric overfit vacuum seal workpiece bearing member are cut seals each having a first end and a second end and arranged such that the first end is in an abutting position to the second end when the first and second perimeter seals are carried by their associated first and second protective elastomeric overfit vacuum seal workpiece bearing members.

6. The vacuum support for supporting a workpiece as recited in claim 1, wherein the first and a second oppositely disposed base plates carry an outwardly disposed locking groove and wherein the first and second protective elastomeric overfit vacuum seal workpiece bearing members each carry a circumferentially inwardly disposed projection, interfittable with the associated one of the outwardly disposed locking grooves of the first and a second oppositely disposed base plates to facilitate the first and second protective elastomeric overfit vacuum seal workpiece bearing members to be removed from their associated first and a second oppositely disposed base plates manually.

7. The vacuum support for supporting a workpiece as recited in claim 1, wherein each of the protective elastomeric overfit vacuum seal workpiece bearing members each have a workpiece bearing first side having a floor from which a first plurality of support projections protrudes in order to provide a space for vacuum to be transmitted between the first plurality of support projections.

8. The vacuum support for supporting a workpiece as recited in claim 7, wherein each of the protective elastomeric overfit vacuum seal workpiece bearing members each have a base plate bearing second side having a floor from which a second plurality of support projections protrudes in order to provide a space for vacuum to be transmitted between the second plurality of support projections.

9. The vacuum support for supporting a workpiece as recited in claim 1, wherein each of the protective elastomeric overfit vacuum seal workpiece bearing members each have a base plate bearing second side having a floor from which a second plurality of support projections protrudes in order to provide a space for vacuum to be transmitted between the second plurality of support projections.

10. The vacuum support for supporting a workpiece as recited in claim 1 wherein the first and second perimeter seals have a solid rubber structure.

11. The vacuum support for supporting a workpiece as recited in claim 1, wherein the first and a second oppositely disposed base plates are identical, and wherein the first and second protective elastomeric overfit vacuum seal workpiece bearing member are identical.

12. The vacuum support for supporting a workpiece as recited in claim 1, wherein the first base plate has a height made to within a first tolerance, wherein the second base plate has a height made to within a second tolerance, wherein the first protective elastomeric overfit vacuum seal workpiece bearing member has a height made to within a third tolerance, wherein the second protective elastomeric overfit vacuum seal workpiece bearing member has a height made to within a fourth tolerance, and wherein the plurality of support posts supporting the base plates with respect to each other have a height made to within a fifth tolerance to facilitate a field repairable vacuum support having an overall height within the sum of the first, second, third, fourth, and fifth tolerances.

13. The vacuum support for supporting a workpiece as recited in claim 12, wherein the first and a second tolerances are identical, and wherein the third and fourth tolerances are identical.

14. The vacuum support for supporting a workpiece as recited in claim 1, wherein the first sides of the first and second protective elastomeric overfit vacuum seal workpiece bearing member have a plurality of frusto-pyramidal projections to both provide even support and facilitate vacuum distribution across the first sides of the first and second protective elastomeric overfit vacuum seal workpiece when bearing against a surface.

15. The vacuum support for supporting a workpiece as recited in claim 1, wherein the second sides of the first and second protective elastomeric overfit vacuum seal workpiece bearing member have a plurality of frusto-pyramidal underside projections to both provide even support and facilitate vacuum distribution across the second sides of the first and second protective elastomeric overfit vacuum seal workpiece when bearing against their respective one of the first and second base plates.

16. The vacuum support for supporting a workpiece as recited in claim 15, wherein the first sides of the first and second protective elastomeric overfit vacuum seal workpiece bearing member have a plurality of frusto-pyramidal projections oriented generally oppositely to the frusto-pyramidal underside projections to both provide even support and facilitate vacuum distribution across the first sides of the first and second protective elastomeric overfit vacuum seal workpiece when bearing against a surface.

17. The vacuum support for supporting a workpiece as recited in claim 16, wherein the plurality of frusto-pyramidal projections of the first sides of the first and second protective elastomeric overfit vacuum seal workpiece bearing member have a surface formed by material removal to achieve at least one of height tolerance and enhanced frictional engagement.
